(19) United States
(12) Patent Application Publication
(10) Pub. No.: US 2001/0032833 A1
(43) Pub. Date: Oct. 25, 2001

(54) Heater for the key entry of a vehicle

(76) Inventor: Jerry R. Collins, Indianapolis, IN (US)

Correspondence Address: Woodard, Emhardt, Naughton, Moriarty and McNett, Bank One Center/Tower, Suite 3700, 111 Monument Circle, Indianapolis, IN, 46204-5137, US

(21) Appl. No.: 09/760,552

(22) Filed: Jan. 16, 2001

Related U.S. Application Data
(60) Provisional application No. 60/180,731, filed on Feb. 7, 2000.

(51) Int. Cl. B60L 1/02

(52) U.S. Cl. 219/202; 219/526

(57) ABSTRACT

A removable heater for attachment onto the body of a vehicle and over the key entry of vehicle lock. The heater has a housing with an open bottom and the leading edges of the housing have a gasket that seals the housing over the key access of the lock. A heating element is attached inside the housing and two wires electrically connect the heater to a power source. At least one suction cup is then attached to fixedly secure open bottom of the heater over the external face of a vehicle lock. In addition to or separate from the suction cup(s), the heater may be attached with a magnet.

This application claims priority from provisional application Ser. No. 60/180731 filed on Jan. 14, 2000.

This invention relates to automobile door lock warmers.

### BACKGROUND OF THE INVENTION

In cold climates, and particularly in cold and humid climates, freeze-up of automobile door locks is an annoying problem. The freeze-up is caused by an accumulation of moisture within the door lock, and also by the simple freezing of lubricants within the lock mechanism itself. The problem is particularly acute in regions affected with freezing rain. Also, in very cold climates, the hands of an automobile owner may become numb by the cold to an extent where it is impossible to manipulate the key in the lock. This, in conjunction with the aforementioned lock freeze-up problems has frustrated many vehicle owners.

The following is one solution to this problem.

### SUMMARY OF THE INVENTION

In one aspect, the present invention is a removable heater for attachment onto the body of a vehicle and over the external face of vehicle lock. The invention has a housing with an open bottom and the leading edges of the housing have a gasket that seals the housing over the key access of the lock. A heating element is attached inside the housing and two wires electrically connect the heater to a power source. At least one suction cup is attached to the housing to fixedly secure the open bottom of the heater over the external face of a vehicle lock.

In another aspect, the present invention is a removable heater for attachment onto the body of a vehicle and over the external face of vehicle lock. The invention has a housing with an open bottom and the leading edges of the housing have a gasket that seals the housing over the key access of the lock. A heating element is attached inside the housing and two wires electrically connect the heater to a power source. A magnet is then used, preferably attached to the gasket, to fixedly secure the open bottom of the heater over the external face of a vehicle lock.

### BRIEF DESCRIPTION OF THE DRAWINGS

FIG. 1 is a plan view of a removable heater for attachment onto the body of a vehicle and over the external face of vehicle lock according to one embodiment of the present invention.

FIG. 2 is a side view of a removable heater for attachment onto the body of a vehicle and over the external face of vehicle lock according to one embodiment of the present invention.

FIG. 3 is a sectional view of a removable heater for attachment onto the body of a vehicle and over the external face of vehicle lock according to one embodiment of the present invention.

FIG. 4 is a schematic view of four electrical connections to a removable heater for attachment onto the body of a vehicle and over the external face of vehicle lock according to one embodiment of the present invention.

FIG. 5 is side view of a removable heater for attachment onto the body of a vehicle and over the external face of vehicle lock attached to automobile's door according to one embodiment of the present invention.

FIG. 6 is a sectional view of an alternative gasket and suction cup for a removable heater for attachment onto the body of a vehicle and over the external face of vehicle lock according to one embodiment of the present invention.

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further applications of the principles of the invention as illustrated therein being contemplated as would normally occur to one skilled in the art to which the invention relates.

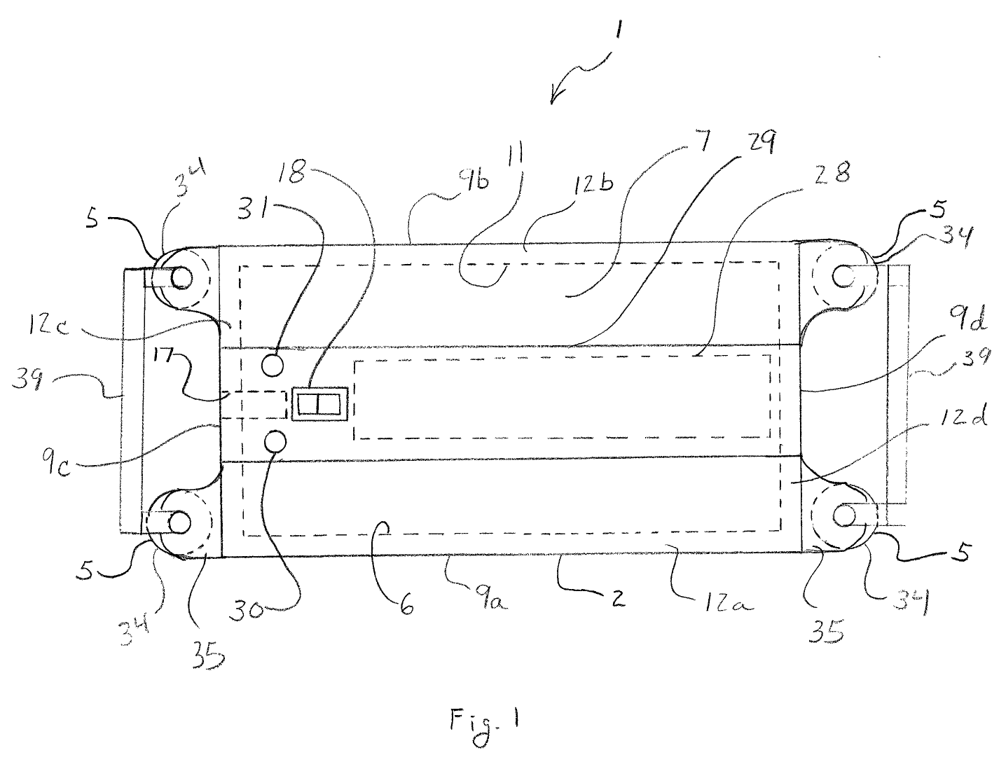

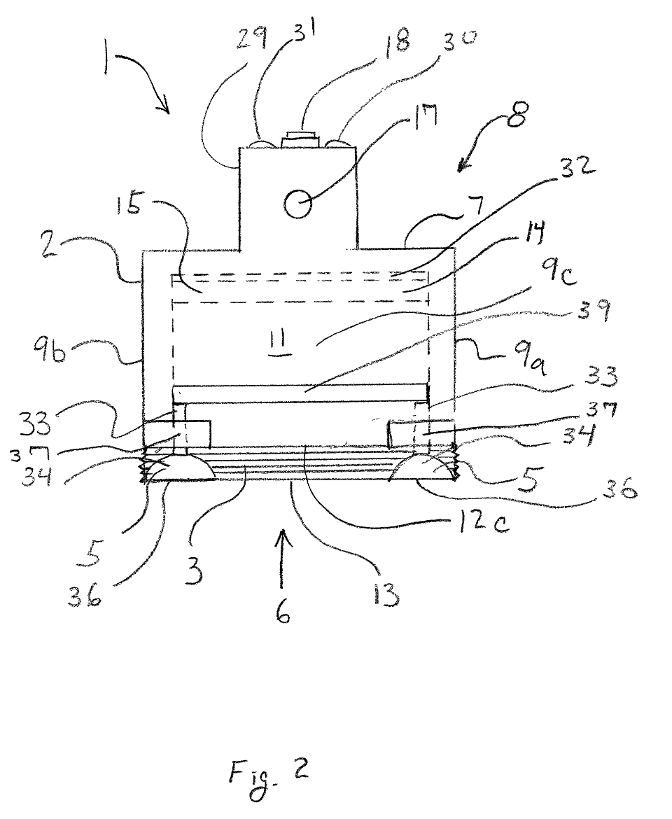

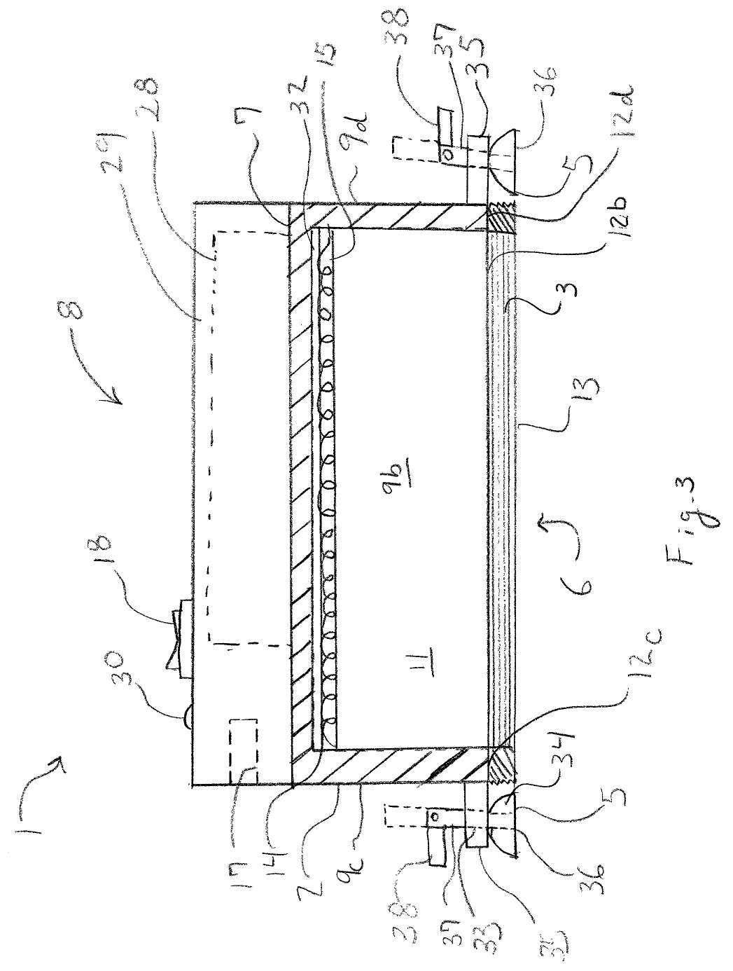

Referring to FIG. 1, there is shown a heater 1 according to one embodiment of the invention. Heater 1 includes housing 2, gasket 3 (FIG. 2), and suction cups 5. Housing 2 is preferably rectangular in shape, but it is contemplated that it could also take other shapes. For example, housing 2 could be square, hemispherical (domed), triangular, or basically about any shape that will satisfactorily cover the exterior of the lock for which the heater is to be used. Regardless of shape, housing 2 has an open bottom 6 (FIGS. 2 or 3), a top 7, and sides 9 (here, 9a, 9b, 9c and 9d), with sides 9 and top 7 generally defining the exterior 8 of housing 2 and chamber 11 therein. Housing 2 is preferably made of plastic and is preferably molded as one piece, but it is also contemplated that housing 2 could be made of multiple pieces and that it could be made of other materials, such as a metal, for example aluminum or steel.

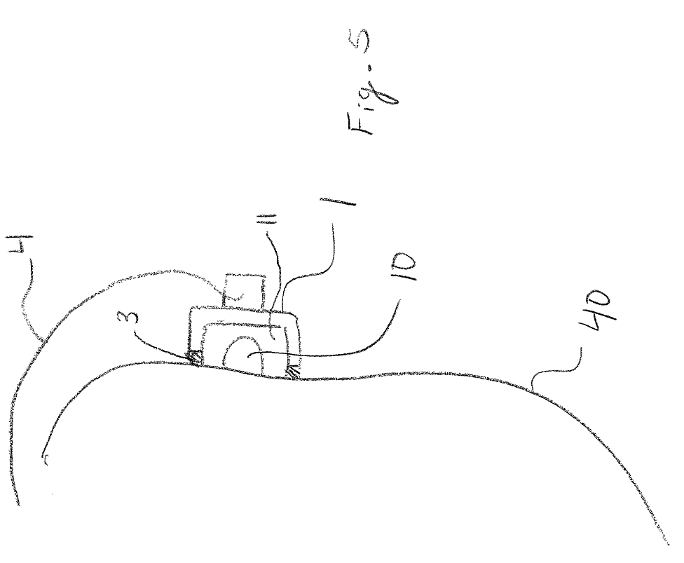

Gasket 3 is generally mounted around the bottom or leading edges 12 of sides 9 (here, edges 12a, 12b, 12c, and 12d). Collectively edges 12 define the opening in open bottom 6 that opens into chamber 11. Gasket 3 helps provide a seal between the body 40 of a car (FIG. 5) and chamber 11 around door handle or lock 10. Gasket 3 is preferably made of an elastomeric material such as rubber or vinyl and is sufficiently thick to seal against a curved surface, such as that commonly found on automobile doors, around the exterior face of a lock. Further, gasket 3 may include a magnet 13 along its leading edge to help seal and hold heater 1 against the side of the automobile; similarly to the method that most modern refrigerator doors are currently held closed and sealed. In one alternative embodiment, no suction cups are necessary, as the magnets, by themselves, may be sufficiently strong to secure and seal the heater to the body of the automobile.

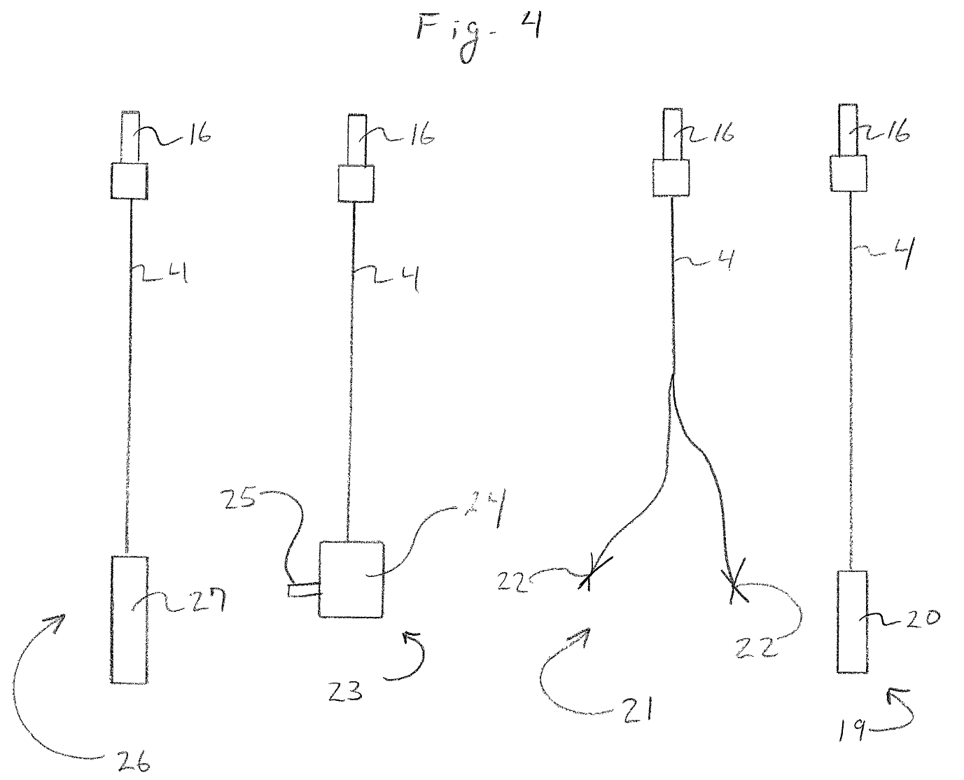

Heater 1 further includes a heating element 14 fixedly secured inside chamber 11, and preferably, as shown, is secured to the bottom of top 7. Heating element 14 is generally a commercially available electrical resistance-heating element, which is commonly sold rolled into a helix. Heating element 14 is surrounded by a silicon bedding 15 so that the wires may provide heat while not physically exposing heating element 14. A layer of insulation 32 is then preferably located between heating element 14 and top 7 of housing 2. Heating element 14 is electrically connected between the two wires 4 (FIG. 4), which provide direct current power to the element. Each of wires 4 shown in FIG. 4 are electrically connected by placing a male electrical plug 16 into a complementary female electrical socket 17. A switch 18 is then placed in series between female socket 17 and heating element 14 to control the flow of power to element 14.

In general, power to element 14 may be provided in one of four ways. Referring to FIG. 4, a first is power supply 19. Power supply 19 connects power to heater 1 by electrically connecting heating element 14 to the automobile's battery. This is accomplished by electrically connecting wires 4 to the automobile's cigarette lighter (not shown) by a commercially available cigarette lighter plug connection 20. A second power supply is 21. Power supply 21 also connects power to heater 1 by electrically connecting heating element 14 to the automobile's battery. But here, this is accomplished by directly connecting wires 4 to the automobile's battery with a commercially available battery clip 22 that is attached to the distal end of each of wire. The clips are then clamped onto a battery pole on the automobile's battery (not shown). A third power supply is 23. Power supply 23 connects power to heater 1 by electrically connecting heating element 14 to household alternating current. A commercially available transformer 24 is provided, which converts household current, typically 120 volts alternating current to 12 volts direct current to run element 14. The transformer is connected to a common household outlet (not shown) via standard 110-volt prongs that extend out the side of such commercially available transformers. A fourth power supply is 26. Power supply 26 connects power to heater 1 by electrically connecting heating element 14 to a battery 27. Battery 27 may be rechargeable or not rechargeable, and may be optionally located inside housing 2 inside chamber 28 (FIG. 1), which is located inside a handle 29 that is attached to the exterior of housing 2. In its preferably preferred configuration, heater 1 further includes indicator lights 30 and 31, which respectively light when heater 1 is turned on and when battery 27 may be charging.

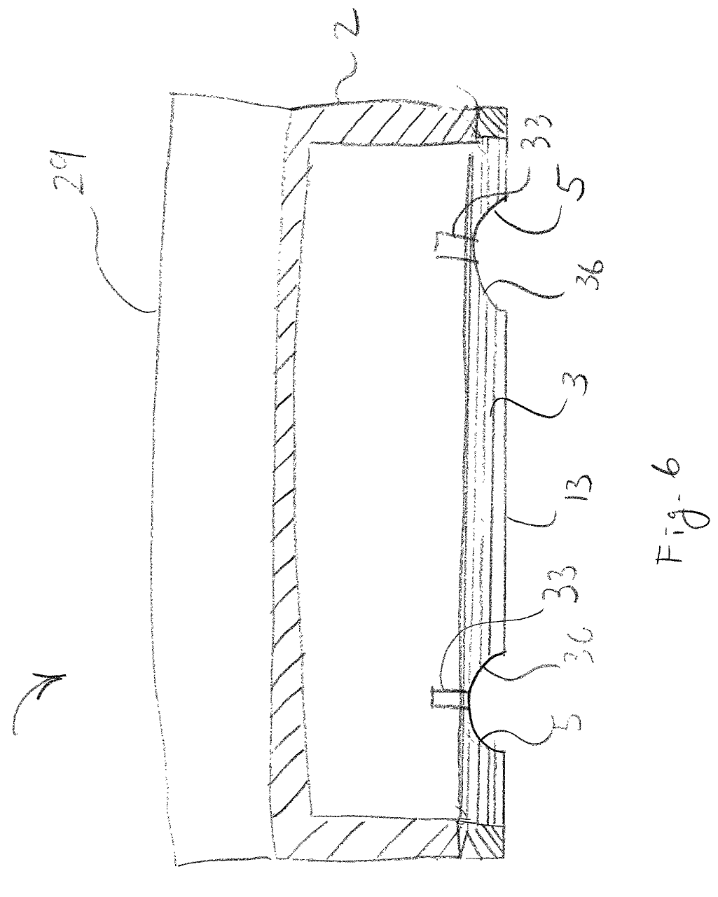

Besides or in addition to magnet 13, heater 1 may be held onto the body of an automobile by commercially available suction cups 5. In general, suction cups 5 have a stem 33 and a bell 34. The stem of each cup is fixedly secured to housing 2 with most any suitable structure. In the depicted embodiment, a tab 35 is provided for this purpose. As shown, these suction cups are mounted on the short end of the heater, optionally however, one may locate these suction cups along the longer sides. Further optionally, one may also locate them integral with or attached to gasket 3 such that the bell 36 of each suction cup is an integral part of the gasket 36. In other words, the bell 36 may be directly molded into the gasket 3. This optional embodiment is depicted in FIG. 6. The bell 34 is then pressed against the side of the automobile to hold heater 1 in place. In one embodiment suction cups 5 are of a commercially available type that have a membrane 36 across the bottom. The membrane is mechanically connected to a shaft 37, which in turn, is connected to a lever 38. When bell 34 and membrane 36 is placed against the side of the auto, lever 38 is moved which via shaft 37, pulls the membrane away from the body to provide a vacuum between the suction cup and the auto. As shown, two of the levers 37 may be mechanically connected to a bar 39 that allows the user to operate two suction cups at once.

Referring to FIG. 5, heater 1 is operated by attaching it over the key entry of an automobile lock, connecting power to the device, and turning the switch to on. The heating time may very depending how much ice is present inside the lock that caused the lock to malfunction.

While the invention has been illustrated and described in detail with specific drawings and words, the same is to be considered as illustrative and not restrictive in character, it being understood that only the preferred embodiment has been shown and described and that all changes and modifications that come within the spirit of the invention are desired to be protected.

I claim::

1. A removable heater for attachment onto the body of a vehicle and over the key entry of vehicle lock, comprising:
a housing having an open bottom, a top, an exterior, and sides, the sides having a leading edge that at least partially defines the open bottom, said housing having a chamber therein;
a gasket fixedly secured over the leading edge of said housing;
a heating element attached to said housing and inside the chamber therein;
at least one suction cup having a bell portion and stem portion, the stem portion attached to said housing such that the bell portion can removably secure the open bottom of the housing against the body of a vehicle and over the key entry of a vehicle lock.

2. The removable heater of claim 1, including an electrical switch operatively connected to said heating element.

3. The removable heater of claim 1, including two wires, each having a proximal end and a distal end, the proximal ends of each wire electrically connected to said heating element to connect power to said heating element and a cigarette lighter electrical connection operatively attached to the distal end of said two wires.

4. The removable heater of claim 1, wherein at least one of said suction cups is an integral part of said gasket.

5. The removable heater of claim 1, including a handle fixedly secured to the exterior of said housing.

6. The removable heater of claim 1, including two wires, each having a proximal end and a distal end, the proximal ends of each wire electrically connected to said heating element to connect power to said heating element and an alternating current to direct current transformer operatively electrically connected to said wires.

7. The removable heater of claim 1, including a rechargeable battery electrically connected to said heating element.

8. A removable heater for attachment onto the body of a vehicle and over the key entry of a vehicle lock, comprising:
a housing having an open bottom, a top, an exterior, and sides, the sides having a leading edge that at least partially defines the open bottom, said housing having a chamber therein;
a gasket fixedly secured over the leading edge of said housing;
a heating element attached to said housing and inside the chamber therein;
at least one magnet attached to said housing to removably secure the open bottom of the housing against the body of a vehicle and over the key entry of a vehicle lock.

9. The removable heater of claim 8, including an electrical switch operatively connected to said heating element.

10. The removable heater of claim 8, including two wires, each having a proximal end and a distal end, the proximal ends of each wire electrically connected to said heating element to connect power to said heating element and a cigarette lighter electrical connection operatively attached to the distal end of said two wires.

11. The removable heater of claim 8, including at least one suction cup attached to said gasket.

12. The removable heater of claim 8, including a handle fixedly secured to the exterior of said housing.

13. The removable heater of claim 8, including two wires, each having a proximal end and a distal end, the proximal ends of each wire electrically connected to said heating element to connect power to said heating element and an alternating current to direct current transformer operatively electrically connected to said wires.

14. The removable heater of claim 8, including a rechargeable battery electrically connected to said heating element.

15. A removable heater for attachment onto the body of a vehicle and over the key entry of a vehicle lock, comprising:
a housing having an open bottom, a top, an exterior, and sides, the sides having a leading edge that at least partially defines the open bottom, said housing having a chamber therein;
a gasket fixedly secured over the leading edge of said housing;
a heating element attached to said housing and inside the chamber therein;
means for removably securing the open bottom of the housing against the body of a vehicle and over the key entry of a vehicle lock.

16. The removable heater of claim 15, including an electrical switch operatively connected to said heating element.

17. The removable heater of claim 15, including two wires, each having a proximal end and a distal end, the proximal ends of each wire electrically connected to said heating element to connect power to said heating element and a cigarette lighter electrical connection operatively attached to the distal end of said two wires.

18. The removable heater of claim 15, including at least one suction cup attached to said gasket.

19. The removable heater of claim 15, including two wires, each having a proximal end and a distal end, the proximal ends of each wire electrically connected to said heating element to connect power to said heating element and an alternating current to direct current transformer operatively electrically connected to said wires.

20. The removable heater of claim 15, including a rechargeable battery electrically connected to said heating element.
